(19) United States
(12) Patent Application Publication
(10) Pub. No.: US 2006/0205267 A1
(43) Pub. Date: Sep. 14, 2006

(54) ELECTRICAL CONNECTOR AND METHOD OF PRODUCING SAME

(75) Inventors: Christopher J. Darr, Livonia, MI (US); John N. Topolewski, Westland, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/906,901

(22) Filed: Mar. 11, 2005

(51) Int. Cl. H01R 4/26

(52) U.S. Cl. 439/441

(57) ABSTRACT

An electrical connector is provided which includes a generally planar body having first and second retaining arms. The retaining arms are electrically connected to each other and disposed opposite each other. The first and second retaining arms are flexible in a direction away from each other for receiving an electrically conducting element therebetween. This facilitates electrical contact between the retaining arms and the electrically conducting element. A wire retaining structure is electrically connected to the body. At least a portion of the wire retaining structure is movable to at least partially surround an electrically conducting wire to make electrical contact with, and to retain, the wire.

### BACKGROUND OF THE INVENTION

1. Field of the Invention

The present invention relates to an electrical connector and a method of producing an electrical connector.

2. Background Art

Electrical systems which require some modularity, and in particular, selective use of various types of electronic modules, often use various types of electrical connectors to facilitate changing configurations. Such systems are prevalent, for example, in automotive and other types of vehicles. A power distribution center in a vehicle may contain a variety of different electronic components, such as fuses and relays. To facilitate maintenance, it is important that such electronic components can be easily inserted and removed. Moreover, it may be desirable to have a power distribution center that can receive a variety of different electronic components, thereby providing different power distribution schemes for a single power distribution center.

In order to facilitate this type of modular design, a power distribution center may be configured with female electrical terminals that are configured to receive mating terminals from electronic components, such as fuses, relays, and the like. One common type of female terminal used in power distribution centers is a “box” terminal. Box terminals may provide good retention for the mating electronic components, but are unnecessarily complex and costly. For example, a box terminal may be manufactured in a progressive die stamping operation which may take six or more steps to complete. The box terminal is closed on all four sides, and is stamped and folded to create a relatively complex geometry. Box terminals may include crimping devices so the terminal can be directly attached to a wire. In some cases, a box terminal is made as a double-box, with a box on each end. This allows one box of the double-box terminal to mate with a male component in a power distribution center—e.g., an electrical bus—while the other box can be used to mate with an electrical component, such as a fuse or a relay.

Although a box terminal may provide good retention strength for a mating electrical component, it would be desirable to have a female electrical component with good retention strength, but having less complex geometry. This could lower material and/or labor costs, which could result in a significant production cost savings for an assembly, particularly in applications where many electrical connectors are used.

### SUMMARY OF THE INVENTION

Accordingly, the present invention provides an electrical connector that includes a generally planar body having first and second retaining arms electrically connected to each other and disposed opposite of each other. The first and second retaining arms are flexible in a direction away from each other for receiving an electrically conducting element therebetween. This facilitates electrical contact between the retaining arms and the electrically conducting element. A wire retaining structure is electrically connected to the body. At least a portion of the wire retaining structure is movable to at least partially surround an electrically conducting wire to make electrical contact with, and retain, the wire.

The invention also provides an electrical connector that includes a generally planar base having a first surface defining a first plane, and a second surface defining a second plane. A first retaining arm is electrically connected and cantilevered to the first base. The first retaining arm has a first surface lying generally within the first plane and a second surface lying generally with the second plane. A second retaining arm is electrically connected and cantilevered to the first base, and has a first surface lying generally within the first plane, and a second surface lying generally with the second plane. The second retaining arm is disposed opposite the first retaining arm such that a gap is formed therebetween. This facilitates insertion of a first electrically conducting element between the first and second retaining arms. A wire retaining structure is electrically connected to the first and second retaining arms, and is configured for electrical connection to, and retention of, an electrically conducting wire.

The invention further provides a method of producing an electrical connector. The method includes forming a unitary, generally planar body including first and second retaining arms disposed opposite of each other. This forms a gap between at least a portion of the first and second retaining arms. Each of the retaining arms have first and second ends. Each of the first ends of the first and second retaining arms are electrically connected to each other by a portion of the body. Each of the second ends of the first and second retaining arms are separated by a portion of the gap. A wire retaining structure is formed integrally with the body. The wire retaining structure is configured to receive an electrically conducting wire and to retain the wire and electrically connect the wire to the body.

### BRIEF DESCRIPTION OF THE DRAWINGS

FIG. 1 is a perspective view of an electrical connector in accordance with the present invention;

FIG. 2 is a partially fragmentary cross-sectional view of the connector shown in FIG. 1, inserted into a connector housing;

FIG. 3 is a top plan view of the connector shown in FIG. 1 having a wire attached thereto;

FIG. 4 is a side plan view of an automotive fuse attached to two electrical connectors made in accordance with the present invention; and

FIG. 5 is an electrical connector in accordance with the present invention including multiple pairs of retaining arms and a single wire retaining structure.

### DETAILED DESCRIPTION OF THE PREFERRED EMBODIMENT(S)

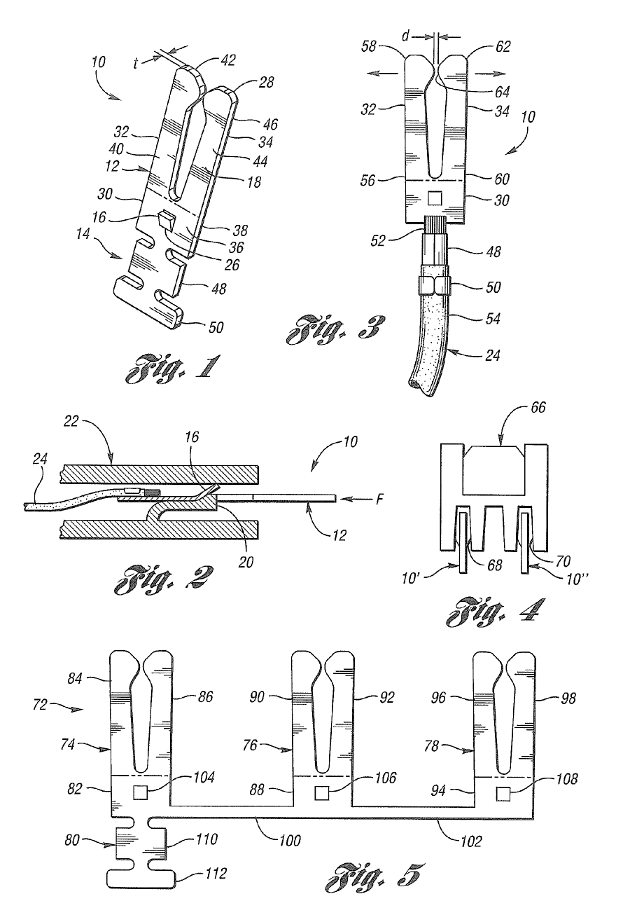

FIG. 1 shows an electrical connector 10 in accordance with an embodiment of the present invention. The electrical connector 10 is a female forked terminal which can be used in a variety of applications, for example, replacing a more complex box terminal. The connector 10 includes a generally planar body 12, which is electrically connected to a wire retaining structure 14. The entire connector 10 is of generally uniform thickness (t), and can be formed in a single stamping operation. As noted above, the body 12 is generally planar, but in the embodiment shown in FIG. 1, it includes a retention feature, or tab 16, which extends out of a first plane defined by a first surface 18 of the body 12.

In the embodiment shown in FIG. 2, the tab 16 cooperates with a flexible arm 20 which is formed as part of a connector housing 22. The connector housing 22 may be, for example, a portion of a power distribution center for a vehicle. Also shown in FIG. 2 is a wire 24, the attachment of which to the connector 10 is explained more fully below. As shown in FIG. 2, the cooperation of the tab 16 and the flexible arm 20 allow the connector 10 to be easily inserted into the housing 22, and yet remain securely attached when a mating electrical element is attached to the connector 10. Such an electrical element would be attached to the connector 10 in the direction of the arrow indicating a force (F), as shown in FIG. 2.

Returning to FIG. 1, it is shown that the tab 16 is integrally formed with the body 12, and attached along one side 26. Of course, a tab, such as the tab 16, may be attached along any number of sides, including all four sides. In such a case, the retention feature, or tab, would essentially be a dimple that would form a concavity in a second surface 28 of the body 12. As discussed below in conjunction with FIG. 5, a retention feature for an electrical connector, such as the connector 10, may be formed by an aperture, thereby eliminating a tab altogether.

The body 12 includes a base 30 and first and second retaining arms 32, 34. The base 30 is designated generally as that portion of the body 12 below the retaining arms 32, 34. This is shown in FIG. 1 by the phantom line which traverses the body 12 at the base of the arms 32, 34. As shown in FIG. 1, the connector 10 is a unitary structure that can be produced from a flat piece of electrically conducting material, such as tin plated copper.

The base 30 includes first and second surfaces 36, 38. Similarly, the first retaining arm 32 includes first and second surfaces 40, 42, and the second retaining arm 34 includes first and second surfaces 44, 46. Because the connector 10 is a unitary structure formed from flat-stock material, the plane defined by the first surface 18 of the body 12 includes the first surfaces 36, 40, 44 of the base 30 and retention arms 32, 34. Similarly, the plane defined by the second surface 28 of the body 12 includes each of the second surfaces 38, 42, 46 of the base 30 and the retaining arms 32, 34. Although a wire retaining structure, such as the structure 14, could be attached to the base 12 in a separate operation, it may be convenient and cost effective to make the wire retaining structure integral with the base, as shown in FIG. 1.

The wire retaining structure 14 includes two pairs of crimp wings 48, 50. Each of the pairs of crimp wings 48, 50 are movable to surround at least a portion of an electrically conducting wire, such as the wire 24, shown in FIGS. 2 and 3. Turning to FIG. 3, a detailed view of the attachment of the wire 24 to the connector 10 is shown. The first pair of crimp wings 48 can be wrapped around a conducting portion 52 of the wire 24. This provides electrical contact between the wire 24 and the wire retaining structure 14. Because the wire retaining structure 14 is electrically connected to the body 12 of the connector 10, there is also an electrical connection between each of the retaining arms 32, 34 and the wire 24. As shown in FIG. 3, the wire 24 includes a non-conducting portion, or insulation 54. The second pair of crimp wings 50 are wrapped around the insulation 54 to retain the wire 24 in place. This helps to relieve the strain from the conducting portion 52 if the wire 24 is inadvertently tensioned.

As shown in FIG. 3, the retaining arm 32 includes a first end 56 and a second end 58. Similarly, the second retaining arm 34 includes a first end 60, and a second end 62. Each of the first ends 56, 60 are electrically connected to each other by the base 30, to which each of them are cantilevered. Conversely, the second ends 58, 62 are separated by a gap 64, defined by a distance (d). The retaining arms 32, 34, which are disposed opposite each other, are flexible in a direction away from each other, as indicated by the direction arrows in FIG. 3. This flexibility allows an electrically conducting element, such as those found on a fuse or a relay, to be inserted between the retaining arms 32, 34, thereby making electrical contact between the retaining arms 32, 34 and the conducting element.

FIG. 4 shows an example of an automotive type fuse 66 attached to two electrical connectors 10′, 10″. Only a portion of the connectors 10′, 10″ are shown in FIG. 4; however, it is understood that they may be of the same or similar configuration as the connector 10 shown in the other drawing figures. The fuse 66 includes two electrically conducting elements 68, 70. Each of the elements 68, 70 are male terminals which have a thickness at least slightly larger than the gap between the retaining arms of each of the connectors 10′, 10″. For example, if the connectors 10′, 10″ each have a gap defined by a distance (d)—see, for example, FIG. 3—then the terminals 68, 70 may have a thickness (d′) which is greater than (d). In this way, the terminals 68, 70 are electrically connected to the connectors 10′, 10″, which in turn, would be connected to an electrically conducting wire, such as the wire 24 shown in FIGS. 2 and 3.

Because different applications may require different current loads, electrical connectors in accordance with the present invention can be appropriately configured to meet these requirements. For example, the distance (d) of the gap 64 can be reduced to generate a higher normal force on a mating terminal, such as the terminals 68, 70 shown in FIG. 4. Moreover, the configuration of the retaining arms 32, 34 can also affect the normal forces applied to a mating terminal. An increase in the normal forces, as well as an increase in the contact area, may be realized by increasing the thickness (t) of the retaining arms 32, 34. Thus, the present invention provides the flexibility of electrical connectors having various retention strengths and current carrying capacities.

As discussed above, an electrical connector, such as the connector 10, made in accordance with the present invention, provides the flexibility of a wire attachment without the complexity and cost of a box terminal. Another way the present invention can be used to further decrease costs and simplify production is illustrated in FIG. 5. FIG. 5 shows an electrical connector 72, including a plurality of generally planar bodies 74, 76, 78, but only one wire retaining structure 80. The body 74 includes a first base 82 and first and second retaining arms 84, 86. Similarly, the body 76 includes a second base 88, and third and fourth retaining arms 90, 92. Finally, the body 78 includes a third base 94 and fifth and sixth retaining arms 96, 98. As shown in FIG. 5, each pair of retaining arms includes two retaining arms which are disposed opposite each other. Moreover, each of the retaining arms includes first and second ends, the labels for which are not shown for clarity. Referencing FIG. 3, for example, each of the first ends of the retaining arms shown in FIG. 5 are cantilevered at its respective base. In addition, each pair of retaining arms has a gap between their respective second ends for receiving an electrically conducting element, such as a male terminal found on a fuse or relay.

The connector 72 like the connector 10, can be produced in a single stamping operation thereby keeping manufacturing costs down. Further reducing manufacturing costs is the use of multiple bodies on a single connector. As shown in FIG. 5, the bodies 74, 76 are connected to each other by a carrier strip 100. Similarly, the bodies 76, 78 are connected to each other by a carrier strip 102. It is worth noting that although the embodiment shown in FIG. 5 includes three bodies for a single wire retaining structure 80, more or less than three bodies can be connected as desired.

Each of the bodies 74, 76, 78 includes a retention feature 104, 106, 108, respectively. Instead of the tab 16, shown in the embodiment illustrated in FIG. 1, the retention features 104, 106, 108 are square holes which extend through the thickness of their respective bodies 74, 76, 78. The holes 104, 106, 108 allow the connector 72 to be attached to a connector housing, such as the connector housing 22, shown in FIG. 2. As with the connector 10, the wire retaining structure of the connector 72 includes first and second pairs of crimp wings 110, 112 which are used to electrically connect, and retain, an electrically conducting wire. The thickness of the connector 72, as well as the configuration of the retaining arms, can be varied as desired to meet the requirements of a particular application.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An electrical connector, comprising:
a generally planar body defining a plane and including first and second retaining arms electrically connected to each other and disposed opposite each other, the first and second retaining arms being flexible in a direction away from each other within the plane defined by the body for receiving an electrically conducting element therebetween, thereby making electrical contact between the retaining arms and the electrically conducting element; and
a wire retaining structure electrically connected to the body, at least a portion of the wire retaining structure being movable to at least partially surround an electrically conducting wire to make electrical contact with, and retain, the wire.

2. The electrical connector of claim 1, further comprising:
a plurality of generally planar bodies electrically connected to each other, each of the bodies including a pair of retaining arms electrically connected to and disposed opposite each other, each pair of retaining arms including two retaining arms flexible in a direction away from each other for receiving a respective electrically conducting element therebetween, thereby making electrical contact between each of the electrically conducting elements and the wire retained in the wire retaining structure.

3. The electrical connector of claim 1, wherein each of the retaining arms includes a first end and a second end, and wherein each of the first ends of the first and second retaining arms are electrically connected to each other by a portion of the body, and each of the second ends of the first and second retaining arms are separated by a gap, the gap being defined by a distance between the second ends of the first and second retaining arms.

4. The electrical connector of claim 3, wherein the gap is configured to be less than the thickness of the electrically conducting element to be received between the first and second retaining arms.

5. The electrical connector of claim 1, wherein the wire retaining structure is integral with the body.

6. The electrical connector of claim 1, wherein the wire retaining structure includes a pair of crimp wings, each of the crimp wings being configured to surround at least a portion of the wire.

7. The electrical connector of claim 1, wherein the wire retaining structure includes first and second pairs of crimp wings, each of the crimp wings of the first pair of crimp wings being configured to surround at least a portion of a conducting portion of the wire, thereby making electrical contact between the wire and the wire retaining structure, and each of the crimp wings of the second pair of crimp wings being configured to surround at least a portion of a non-conducting portion of the wire, thereby retaining the wire within the wire retaining structure.

8. The electrical connector of claim 1, wherein the body includes a retention feature formed therein, the retention feature being configured to cooperate with a portion of a connector housing for securing the electrical connector to the connector housing.

9. The electrical connector of claim 8, wherein the retention feature includes a tab, integrally formed in the body, the tab being connected to the body on at least one side and extending out of a plane defined by a surface the body.

10. An electrical connector, comprising:
a generally planar first base having a first surface defining a first plane and a second surface defining a second plane;
a first retaining arm electrically connected and cantilevered to the first base, and having a first surface lying generally within the first plane and a second surface lying generally within the second plane;
a second retaining arm electrically connected and cantilevered to the first base, and having a first surface lying generally within the first plane and a second surface lying generally within the second plane, the second retaining arm being disposed opposite the first retaining arm such that a gap is formed therebetween, thereby facilitating insertion of a first electrically conducting element between the first and second retaining arms; and
a wire retaining structure electrically connected to the first and second retaining arms and configured for electrical connection to, and retention of, an electrically conducting wire.

11. The electrical connector of claim 10, further comprising:
a generally planar second base electrically connected to the first base and having first and second surfaces respectively lying generally within the first and second planes;
a third retaining arm electrically connected and cantilevered to the second base, and having first and second surfaces respectively lying generally within the first and second planes;
a fourth retaining arm electrically connected and cantilevered to the second base, and having first and second surfaces respectively lying generally within the first and second planes, the fourth retaining arm being disposed opposite the third retaining arm such that a gap is formed therebetween, thereby facilitating insertion of a second electrically conducting element between the third and fourth retaining arms and further facilitating electrical connection between the second electrically conducting element and the wire retained by the wire retaining structure.

12. The electrical connector of claim 10, wherein the wire retaining structure is integral with the first base.

13. The electrical connector of claim 10, wherein the wire retaining structure includes a pair of crimp wings, each of the crimp wings being configured to surround at least a portion of the wire.

14. The electrical connector of claim 10, wherein the wire retaining structure includes first and second pairs of crimp wings, each of the crimp wings of the first pair of crimp wings being configured to surround at least a portion of a conducting portion of the wire, thereby making electrical contact between the wire and the wire retaining structure, and each of the crimp wings of the second pair of crimp wings being configured to surround at least a portion of a non-conducting portion of the wire, thereby retaining the wire within the wire retaining structure.

15. The electrical connector of claim 10, wherein the base includes a retention feature formed therein, the retention feature being configured to cooperate with a portion of a connector housing for securing the electrical connector to the connector housing.

16. The electrical connector of claim 15, wherein the retention feature includes a tab, integrally formed in the base, the tab being connected to the base on at least one side and extending out of the plane defined by one of the surfaces of the base.

17. A method of producing an electrical connector, the method comprising:
forming a unitary, generally planar body including first and second retaining arms disposed opposite each other, thereby forming a gap between at least a portion of the first and second retaining arms, each of the retaining arms having first and second ends, each of the first ends of the first and second retaining arms being electrically connected to each other by a portion of the body, and each of the second ends of the first and second retaining arms being separated by a portion of the gap; and
forming a wire retaining structure integral with the body, the wire retaining structure being configured to receive an electrically conducting wire and to retain the wire and electrically connect the wire to the body.

18. The method of claim 17, wherein the body and the wire retaining structure are substantially formed in the same operation.

19. The method of claim 18, wherein the body and the wire retaining structure are formed in a stamping operation.

20. The method of claim 19, further comprising stamping a retention feature into the body when the body and the wire retaining structure are formed, the retention feature being configured to cooperate with a portion of a connector housing for securing the electrical connector to the connector housing.
